(19) United States
(12) Patent Application Publication
(10) Pub. No.: US 2026/0284718 A1
(43) Pub. Date: Sep. 24, 2026

(54) METHOD OF CLEANING COKE FROM AN ENGINE COMPONENT

(71) Applicants: General Electric Company, Evendale, OH (US); GE Aerospace Poland Sp. z o.o., Warsaw (PL)

(72) Inventors: Arundhati Sengupta, Bengaluru (IN); Zeying Chen, Rotterdam, NY (US); Sriram Krishnamurthy, Bengaluru (IN); Rachel Marie Sorell, Albany, NY (US); Bangalore Nagaraj, West Chester, OH (US); Pawel Robert Garczynski, Warsaw (PL)

(21) Appl. No.: 19/232,365

(22) Filed: Jun. 9, 2025

(30) Foreign Application Priority Data
Mar. 24, 2025 (PL) P.451554

(51) Int. Cl. B08B 9/00; F01D 25/00

(52) U.S. Cl. CPC B08B 9/00; F01D 25/002

(57) ABSTRACT

A method of cleaning coke from an engine component. The method includes providing the engine component including a flow passage having coke formed within the flow passage, performing a hot-fluid step including exposing the engine component to a hot fluid, performing a cold-fluid step including exposing the engine component to a cold fluid, and rinsing the engine component with a rinsing fluid. The cold fluid is colder than the hot fluid by a temperature differential to remove the coke from the engine component. The temperature differential is from ninety (90) degrees C. to five hundred fifty-six (556) degrees C.

### CROSS REFERENCE TO RELATED APPLICATIONS

The present application claims the benefit of Polish Patent Application No. P.451554, filed on Mar. 24, 2025, which is hereby incorporated by reference herein in its entirety.

### TECHNICAL FIELD

The present subject matter relates generally to turbine engines, and more particularly, to a method of cleaning coke from an engine component, such as a gas turbine engine.

### BACKGROUND

Turbine engines, for example, for aircraft, generally include a fan and a core section arranged in flow communication with one another. Turbine engines use hydrocarbon fluids, such as fuels and lubricating oils. Such hydrocarbon fluids are conveyed through the engine in various conduits, and the interior surfaces of these conduits contact the hydrocarbon fluids. Carbonaceous deposits (also known as coke) may form on these surfaces when exposed to the hydrocarbon fluids at elevated temperatures, resulting in carbon becoming attached to these surfaces and building up as deposits on these surfaces.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic, cross-sectional view of a turbine engine, taken along a longitudinal centerline axis of the turbine engine, according to the present disclosure.

FIG. 2 is a schematic, cross-sectional view of a combustor of the gas turbine engine shown in FIG. 1, showing detail 2 of FIG. 1.

FIG. 3 is a schematic view of an engine component of the turbine engine shown in FIG. 1.

FIGS. 4A and 4B are flow charts illustrating methods of cleaning the component shown in FIG. 3, according to the present disclosure. FIG. 4A shows performing a cold-fluid step before a hot-fluid step. FIG. 4B shows performing a hot-fluid step before a cold-fluid step.

FIGS. 5A to 5C schematically illustrate a method of cleaning the engine component shown in FIG. 3 using a cleaning system according to the present disclosure. FIG. 5A shows a hot-fluid step. FIG. 5B shows a cold-fluid step. FIG. 5C shows a rinsing step.

FIG. 6 is a schematic view of another cleaning system for cleaning the engine component shown in FIG. 3.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” etc., may be used interchangeably to distinguish one component from another and are not intended to signify location or importance of the individual components unless otherwise specified in a given context.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle. For example, with regard to a turbine engine, forward refers to a position on the turbine engine that is closer to the propeller or the fan and aft refers to a position on the turbine engine that is farther away from the propeller or the fan.

As used herein, the terms “axial” and “axially” refer to directions and orientations that extend substantially parallel to a longitudinal centerline of the turbine engine. Moreover, the terms “radial” and “radially” refer to directions and orientations that extend substantially perpendicular to the longitudinal centerline of the turbine engine. In addition, as used herein, the terms “circumferential” and “circumferentially” refer to directions and orientations that extend arcuately about the longitudinal centerline of the turbine engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, a “turbo-engine” includes a compressor section, a combustion section, and a turbine section.

As used herein, a “turbofan engine” includes a turbo-engine and a fan that directs air into the turbo-engine, and rated for use in a regional aircraft, narrow body aircraft, or wide body aircraft. A turbofan engine rated for use on a regional aircraft will have a maximum takeoff thrust in a range of ten thousand pound-force to twenty thousand pound-force (10,000 lbf to 20,000 lbf). A turbofan engine rated for use on a narrow body aircraft will have a maximum takeoff thrust in a range of fifteen thousand pound-force to thirty thousand pound-force (15,000 lbf to 30,000 lbf). A turbofan engine rated for use on a wide body aircraft will have a maximum takeoff thrust in a range of forty thousand pound-force to one hundred ten thousand pound-force (40,000 lbf to 110,000 lbf).

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a Mach number is a ratio of the speed of the turbofan engine (of the aircraft) to the speed of sound in the surrounding airflow.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one (1), two (2), four (4), ten (10), fifteen (15), or twenty (20) percent margin in either individual values, range(s) of values and/or endpoints defining range(s) of values.

As used herein, any reference to “density” refers density conditions at standard temperature and pressure, including standard atmospheric conditions at sea level, unless specified otherwise.

As used herein, the term “fluid” includes liquids, gases, solid crystals or pellets mixed with one or more gases, and any combination of liquids, gases, or solid crystals or pellets mixed with one or more gases.

As used herein, the terms “hot fluid” and “cold fluid” are generally used in relation to one another, unless, in a particular context, the temperature of the hot fluid or the cold fluid is specified. Thus, generally, a hot fluid is hotter or warmer than a cold fluid, and a cold fluid is colder or cooler than a hot fluid.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Coke can form on surfaces of passages and orifices of a gas turbine engine that are exposed to hydrocarbon fluids, such as fuels and lubricating oils, at elevated temperatures. For example, the fuel nozzle in a combustor includes passages for fuel and orifices to inject fuel into the combustor, and such fuel passages and fuel orifices of the fuel nozzle may be subjected to elevated temperatures suitable for coke formation, particularly, after shutdown during, so-called, soak-back conditions. These fuel passages and fuel offices may be relatively narrow and, as a result of coke formation, may be susceptible to blockages and even clogging.

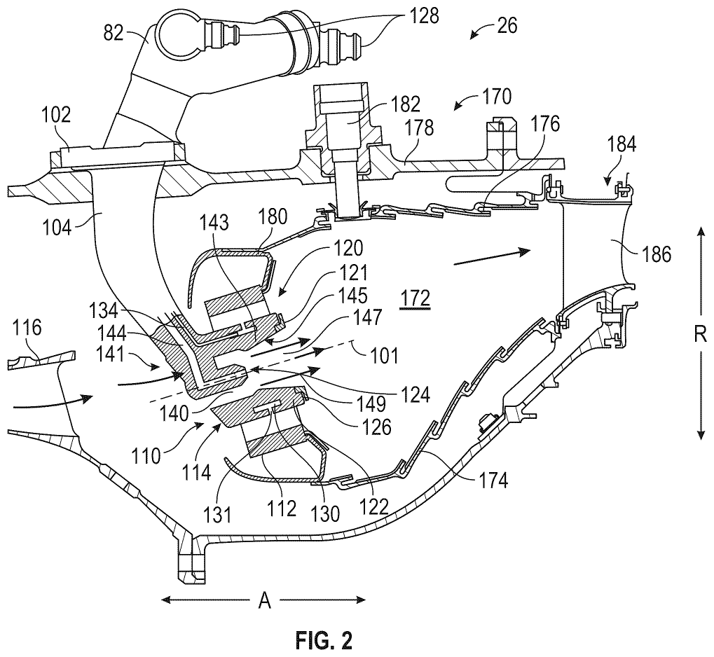

Other surfaces of the gas turbine engine are exposed to elevated temperatures and hydrocarbon fluids. These surfaces can include other surfaces of the fuel nozzle. For example, as shown in FIG. 2, a fuel nozzle aft heat shield 121 (FN-AHS) and surfaces of the mixer assembly are exposed to hydrocarbon fluids, such as fuel, and operation of the gas turbine engine, particularly, continuous operation at cruise for aircraft gas turbine engines, can result in a significant build-up of coke or partially burned fuel deposits, or both, on exposed surfaces of the FN-AHS and the mixer assembly. On these surfaces, coke can build up a considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) may result in spallation of the thermal barrier coating and may reduce the durability of components such as combustors, nozzles, shrouds, and airfoils.

The present disclosure discloses systems and methods of cleaning and removing coke from components of the gas turbine engine, such as the fuel nozzle. The systems and methods herein may be used to clean the inner diameter of narrow passages, including narrow tubes, such as passages of fuel nozzles. The systems and methods discussed herein include a use of cold fluids, such as liquid nitrogen, and hot fluids, such as water and N-Methyl pyrrolidone (NMP), to clean coke from internal surfaces of engine components, such as fuel circuits or oil circuits. Exposing coked surfaces to cold fluids and hot fluids can modify a structure of the coke, which can lead to increased friability of the coke, disruption of a layer of the coke that is sticky and adherent to the engine component, and removal of the coke.

The present disclosure includes methods and systems for unclogging clogged pathways or orifices, or both. The systems and methods herein allow for the debonding of coke from metallic substrates due to thermal shock. An engine component may be exposed to a cold fluid and, then, shortly after, a hot fluid, thereby loosening coke from an interior surface of the engine component. Cyclic exposure of coked surfaces to hot fluids and cold fluids can make the process of removing coke more effective. After debonding of coke from metallic substrates, the coke can be removed such as by rinsing the engine component using, for example, a pressurized flow of fluid to flush the engine component, or suction using, for example, a vacuum pump.

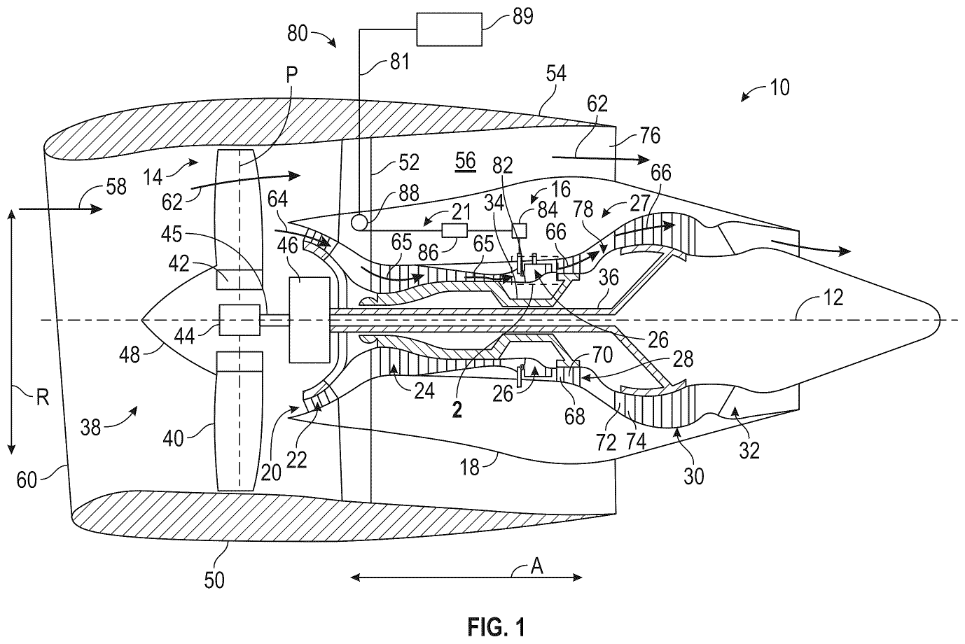

Referring now to the drawings, FIG. 1 is a schematic, cross-sectional view of a turbine engine 10, taken along a longitudinal centerline axis 12 of the turbine engine 10. As shown in FIG. 1, the turbine engine 10 includes an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 includes, in serial flow relationship, a compressor section 21, a combustion section 26, and a turbine section 27. The turbo-engine 16 is substantially enclosed within an outer casing 18 that is substantially tubular and defines a core inlet 20 that is annular about the longitudinal centerline axis 12. As schematically shown in FIG. 1, the compressor section 21 includes a booster or a low pressure (LP) compressor 22 followed downstream by a high pressure (HP) compressor 24. The combustion section 26 is downstream of the compressor section 21. The turbine section 27 is downstream of the combustion section 26 and includes a high pressure (HP) turbine 28 followed downstream by a low pressure (LP) turbine 30. The turbo-engine 16 further includes a jet exhaust nozzle section 32 that is downstream of the turbine section 27, a high-pressure (HP) shaft 34 or a spool, and a low-pressure (LP) shaft 36. The HP shaft 34 drivingly connects the HP turbine 28 to the HP compressor 24. The HP turbine 28 and the HP compressor 24 rotate in unison through the HP shaft 34. The LP shaft 36 drivingly connects the LP turbine 30 to the LP compressor 22. The LP turbine 30 and the LP compressor 22 rotate in unison through the LP shaft 36. The compressor section 21, the combustion section 26, the turbine section 27, and the jet exhaust nozzle section 32, together, define a core air flow path.

For the embodiment depicted in FIG. 1, the fan section 14 includes a fan 38 (e.g., a variable pitch fan) having a plurality of fan blades 40 coupled to a disk 42 in a spaced-apart manner. As depicted in FIG. 1, the fan blades 40 extend outwardly from the disk 42 generally along the radial direction R. In the case of a variable pitch fan, the plurality of fan blades 40 are rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. In this way, the fan 38 is drivingly coupled to, and powered by, the turbo-engine 16, and the turbine engine 10 is an indirect drive engine. The gearbox assembly 46 is shown schematically in FIG. 1. The gearbox assembly 46 is a reduction gearbox assembly for adjusting the rotational speed of the fan shaft 45 and, thus, the fan 38 relative to the LP shaft 36 when power is transferred from the LP shaft 36 to the fan shaft 45.

Referring still to the exemplary embodiment of FIG. 1, the disk 42 is covered by a fan hub 48 that is aerodynamically contoured to promote an airflow through the plurality of fan blades 40. In addition, the fan section 14 includes an annular fan casing or a nacelle 50 that circumferentially surrounds the fan 38 and at least a portion of the turbo-engine 16. The nacelle 50 is supported relative to the turbo-engine 16 by a plurality of outlet guide vanes 52 that are circumferentially spaced about the nacelle 50 and the turbo-engine 16. Moreover, a downstream section 54 of the nacelle 50 extends over an outer portion of the turbo-engine 16, and, with the outer casing 18, defines a bypass airflow passage 56 therebetween.

During operation of the turbine engine 10, a volume of air 58 enters the turbine engine 10 through an inlet 60 of the nacelle 50 or the fan section 14. As the volume of air 58 passes across the fan blades 40, a first portion of air, also referred to as bypass air 62 is routed into the bypass airflow passage 56, and a second portion of air, also referred to as core air 64, is routed into the upstream section of the core air flow path through the core inlet 20 of the LP compressor 22. The ratio between the bypass air 62 and the core air 64 is commonly known as a bypass ratio. The pressure of the core air 64 is then increased, generating compressed air 65. The compressed air 65 is routed through the HP compressor 24 and into the combustion section 26, where the compressed air 65 is mixed with fuel and ignited to generate combustion gases 66.

The combustion gases 66 are routed into the HP turbine 28 and expanded through the HP turbine 28 where a portion of thermal energy or kinetic energy from the combustion gases 66 is extracted via one or more stages of HP turbine stator vanes 68 and HP turbine rotor blades 70 that are coupled to the HP shaft 34. This causes the HP shaft 34 to rotate, thereby supporting operation of the HP compressor 24 (self-sustaining cycle). In this way, the combustion gases 66 do work on the HP turbine 28. The combustion gases 66 are then routed into the LP turbine 30 and expanded through the LP turbine 30. Here, a second portion of the thermal energy or the kinetic energy is extracted from the combustion gases 66 via one or more stages of LP turbine stator vanes 72 and LP turbine rotor blades 74 that are coupled to the LP shaft 36. This causes the LP shaft 36 to rotate, thereby supporting operation of the LP compressor 22 (self-sustaining cycle) and rotation of the fan 38 via the gearbox assembly 46. In this way, the combustion gases 66 do work on the LP turbine 30.

The combustion gases 66 are subsequently routed through the jet exhaust nozzle section 32 of the turbo-engine 16 to provide propulsive thrust. Simultaneously, the bypass air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 includes a fuel system 80 that provides fuel to the combustion section 26. The fuel is mixed with the compressed air 65 from the HP compressor 24 and ignited in the combustion section 26 to produce the combustion gases 66.

The turbo-engine 16 is capable of selectively generating a propulsive thrust for an aircraft. The amount of propulsive thrust may be controlled at least in part based on a volume of fuel provided to the turbo-engine 16 via the fuel system 80. An aviation turbine fuel in the embodiments discussed herein is a combustible hydrocarbon liquid fuel, such as a kerosene-type fuel, having a desired carbon number, a synthetic aviation fuel, a biofuel, a biodiesel, an ethanol, a bioalcohol, and the like. The fuel is stored in a fuel tank 89 of the fuel system 80. The fuel tank 89 may also be separate tanks instead of a single, unitary body, such as, for example, two tanks each located within a corresponding wing of the aircraft.

The turbo-engine 16 is operable with the fuel system 80 and receives a flow of fuel from the fuel system 80. The fuel system 80 includes a fuel delivery assembly 81 providing the fuel flow from the fuel tank 89 to the turbo-engine 16 and, more specifically, to a plurality of fuel nozzles 82 that inject fuel into a combustion chamber 172 (FIG. 2) of a combustor 170 (FIG. 2) of the combustion section 26. The fuel tank 89 is an example of a fuel source that provides fuel to the fuel nozzles 82. The fuel delivery assembly 81 includes tubes, pipes, conduits, and the like, to fluidly connect the various components of the fuel system 80 to the turbo-engine 16. The fuel tank 89 is configured to store the hydrocarbon fuel, and the hydrocarbon fuel is supplied from the fuel tank 89 to the fuel delivery assembly 81. The fuel delivery assembly 81 is configured to carry the hydrocarbon fuel between the fuel tank 89 and the turbo-engine 16, and, thus, provides a flow path (fluid pathway) of the hydrocarbon fuel from the fuel tank 89 to the turbo-engine 16.

The fuel system 80 includes at least one fuel pump fluidly connected to the fuel delivery assembly 81 to induce the flow of the fuel through the fuel delivery assembly 81 to the turbo-engine 16. One such pump is a main fuel pump 88. The main fuel pump 88 is a high-pressure pump that is a primary source of a pressure rise in the fuel delivery assembly 81 between the fuel tank 89 and the turbo-engine 16. The main fuel pump 88 may be configured to increase a pressure in the fuel delivery assembly 81 to a pressure greater than a pressure within the combustion chamber 172 (FIG. 2) of the combustor 170 (FIG. 2).

The fuel system 80 also includes a fuel metering unit 86 in fluid communication with the fuel delivery assembly 81. Any suitable fuel metering unit 86 may be used including, for example, a metering valve. The fuel metering unit 86 is positioned downstream of the main fuel pump 88 and upstream of a fuel manifold 84 configured to distribute fuel to the fuel nozzles 82. The fuel system 80 is configured to provide the fuel to the fuel metering unit 86, and the fuel metering unit 86 is configured to receive fuel from the fuel tank 89. The fuel metering unit 86 is further configured to provide a flow of fuel to the turbo-engine 16 in a desired manner. More specifically, the fuel metering unit 86 is configured to meter the fuel and to provide a desired volume of fuel, at, for example, a desired flow rate, to the fuel manifold 84 of the turbo-engine 16. The fuel manifold 84 is fluidly connected to the fuel nozzles 82 and distributes (provides) the fuel received to the plurality of fuel nozzles 82, where the fuel is injected into the combustion chamber 172 (FIG. 2) and combusted. Adjusting the fuel metering unit 86 changes the volume of fuel provided to the combustion chamber 172 and, thus, changes the amount of propulsive thrust produced by the turbo-engine 16 to propel an aircraft.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. The turbine engine 10 may also be a direct drive engine, which does not have a power gearbox. The fan speed is the same as the LP shaft speed for a direct drive engine. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop, or turboshaft engines.

FIG. 2 is a schematic, cross-sectional view of the combustor 170 of the combustion section 26 according to an embodiment of the present disclosure. Specifically, FIG. 2 is a detail view showing detail 2 in FIG. 1. The combustor 170 is an annular combustor that includes the combustion chamber 172 defined between an inner liner 174 and an outer liner 176. Each of the inner liner 174 and outer liner 176 is annular about the longitudinal centerline axis 12 of the turbine engine 10 (FIG. 1) and may thus extend in a circumferential direction of the turbine engine 10. The combustor 170 also includes a combustor case 178 that is also annular about the longitudinal centerline axis 12 of the turbine engine 10. The combustor case 178 extends circumferentially around the inner liner 174 and the outer liner 176, and the inner liner 174 and the outer liner 176 are located radially inward of the combustor case 178. The combustor 170 also includes a dome 180 mounted to a forward end of each of the inner liner 174 and the outer liner 176. The dome 180 defines an upstream (or a forward end) of the combustion chamber 172.

A plurality of mixer assemblies 110 (only one is illustrated in FIG. 2) are spaced around the dome 180. The plurality of mixer assemblies 110 are circumferentially spaced about the longitudinal centerline axis 12 of the turbine engine 10. In the embodiment shown in FIG. 2, each mixer assembly 110 is a twin annular premixing swirler (TAPS) that includes a main mixer 112 and a pilot mixer 114. The pilot mixer 114 is supplied with fuel during the entire engine operating cycle, and the main mixer 112 is supplied with fuel only during increased power conditions of the engine operating cycle, such as take-off and climb, for example.

The compressor section 21, including the HP compressor 24 (FIG. 1), pressurizes air, and the combustor 170 receives an annular stream of this pressurized air from a discharge outlet (a compressor discharge outlet 116) of the HP compressor 24. This air may be referred to as compressor discharge air. A portion of the compressor discharge air flows into the mixer assembly 110. Fuel is injected into the air in the mixer assembly 110 to mix with the air and to form a fuel-air mixture. The fuel-air mixture is provided to the combustion chamber 172 from the mixer assembly 110 for combustion. Ignition of the fuel-air mixture is accomplished by a suitable igniter 182, and the resulting combustion gases flow in the engine axial direction A toward and into an annular first stage turbine nozzle 184. The annular first stage turbine nozzle 184 is defined by an annular flow channel that includes a plurality of radially extending, circularly spaced nozzle vanes 186 that turn the gases so that the gases flow angularly and impinge upon the first stage turbine blades (not shown) of a first turbine (not shown) of the HP turbine 28 (FIG. 1).

The fuel nozzle 82 is fixed to the combustor case 178 by a nozzle mount. In this embodiment, the nozzle mount is a flange 102 that is integrally formed with a stem 104 of the fuel nozzle 82. The flange 102 is fixed to the combustor case 178 and sealed to the combustor case 178. The stem 104 includes a flow passage through which the fuel flows, and the stem 104 extends radially inward from the flange 102. The fuel nozzle 82 also includes a fuel nozzle tip 120 (and a fuel nozzle axis 101 extending therethrough), and fuel is injected into the combustion chamber 172 through the fuel nozzle tip 120. The fuel nozzle 82 further includes a fuel nozzle body 122.

As noted above, the fuel nozzle 82 shown in FIG. 2 is a TAPS fuel nozzle that includes a main mixer 112 and a pilot mixer 114. Fuel is supplied to the main mixer 112 by a main fuel nozzle 130 and, more specifically, one or more main orifices 131. Fuel is supplied to the pilot mixer 114 by a pilot fuel injector tip 140. As can be seen in FIG. 2, the pilot fuel injector tip 140 may be substantially centered in a pilot inlet 141 that is annular. The main fuel nozzle 130 surrounds the pilot inlet 141, and the pilot inlet 141 is located between the main fuel nozzle 130 and the pilot fuel injector tip 140. The main fuel nozzle 130 includes one or more main orifices 131, such as a plurality of main orifices 131.

As noted above, the fuel system includes a fuel delivery assembly 81 (FIG. 1) to provide fuel to the fuel nozzle 82. The fuel nozzle 82 has valve ends 128 to accept the fuel from the fuel delivery assembly 81. More specifically, the fuel may enter the valve ends 128 to flow through flow passages of the fuel nozzle 82. One of the valve ends 128 accepts fuel for the main fuel nozzle 130, and the fuel flows through a main passage 134 of the fuel nozzle 82. The fuel then exits the main fuel nozzle 130 and is injected into the combustion chamber 172 via the main orifices 131.

Similarly, the other one of the valve ends 128 accepts fuel for the fuel nozzle 82 for the pilot fuel injector tip 140. The fuel flows through a pilot passage 144 through the fuel nozzle 82 until the fuel reaches the pilot inlet 141 and exits through a pilot orifice 124, which is at a fuel-nozzle downstream end 126. The pilot mixer 114 includes pilot swirlers causing air traveling therethrough to swirl. A portion of the compressor discharge air flows into the pilot inlet 141 of the mixer assembly and, then, into the pilot swirlers. As noted above, fuel and the air are provided to the pilot mixer 114 at all times during the engine operating cycle so that a primary combustion zone is produced within a central portion of the combustion chamber 172. The pilot orifice 124 injects fuel in a generally downstream direction and into the compressed air flowing through the pilot swirlers. The pilot mixer 114 is supported by an annular pilot housing 143. The annular pilot housing 143 includes a conical wall section 145 circumscribing a pilot mixing chamber 147 that is in flow communication with, and downstream from, the pilot mixer 114. The fuel and air mixture flows through the pilot mixing chamber 147, where the fuel and the air are further mixed, through an outlet 149 of the pilot mixing chamber 147, and into the combustion chamber 172.

Immediately after shutdown, so-called soak back heating occurs. At shutdown, a flow of the fuel through the main passage 134 and the main orifices 131, and a flow of fuel through the pilot passage 144 and the pilot inlet 141 stagnates. Then, both the temperature of the fuel and of interior surfaces of the main passage 134 and the main orifices 131, and interior surfaces of the pilot passage 144 and pilot inlet 141 increase to temperatures above a coke formation temperature. At these temperatures, the interior surfaces of the main passage 134 and the main orifices 131 and of the pilot passage 144 and pilot inlet 141, which are exposed to the fuel and made from metal, may be susceptible to a significant build-up of coke. Under such conditions, coke can build up over time to a considerable thickness, restricting or even blocking the flow of the fuel through the fuel nozzle 82, including through the main passage 134 and the pilot passage 144. Further, the build-up of coke may clog the orifices of the fuel nozzle 82, such as the main orifices 131 or the pilot inlet 141.

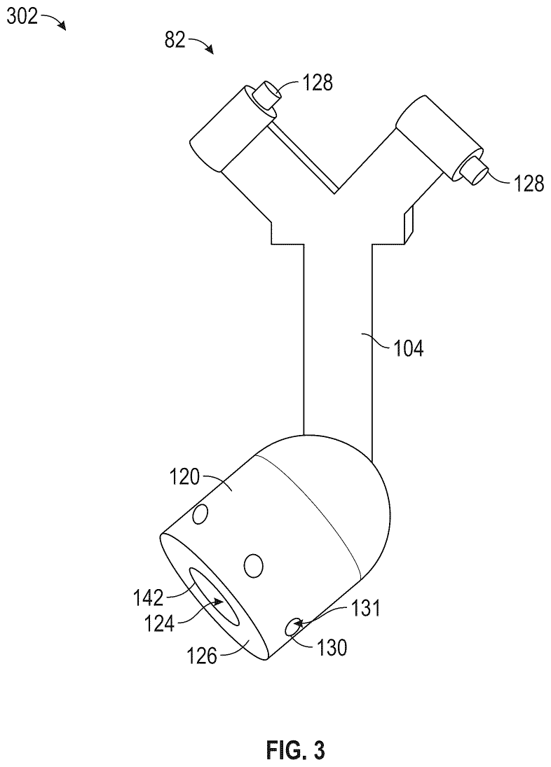

FIG. 3 shows an engine component 302, which can be used in the combustor 170 shown in FIG. 2. More specifically, the engine component 302 shown in FIG. 3 is the fuel nozzle 82 discussed above. The engine component 302 can have a fluid passage and openings, through which a hydrocarbon fluid can flow, such as, for example, the main passage 134 (FIG. 2) and the pilot passage 144 (FIG. 2). As noted above, such fluid passages and openings can have coke deposits formed thereon, requiring cleaning. As discussed above, fluid may enter the fuel nozzle 82 through the valve ends 128 and may then flow through the stem 104 until reaching the fuel nozzle tip 120. Upon reaching the fuel nozzle tip 120, the fluid may exit the fuel nozzle 82 via main orifices 131 of the main fuel nozzle 130, and coking may form in the main orifices 131 as the fuel exits through the main orifices 131. Likewise, upon reaching the fuel nozzle tip 120, the fluid may exit the fuel nozzle 82 via the pilot orifice 124 of the pilot nozzle 142 at the fuel-nozzle downstream end 126. Systems and methods of this disclosure can be used to clean the coke from these fluid passages and orifices of the fuel nozzle 82. The fuel nozzle 82 is used as an example of the engine component 302, but the cleaning methods and systems are not restricted to fuel nozzles 82. Rather, the systems and methods may be applied to any engine component 302 generally. Thus, the systems and methods herein apply to any engine component 302 experiencing coked surfaces that experience a flow of hydrocarbon fluids. The engine component 302 can be other components of the fuel system that are exposed to high temperatures and fuel, leading to coking. Other hydrocarbon fluids are used in the turbine engine 10 (FIG. 2), and the engine component 302 can be components of these other systems. For example, the turbine engine 10 can include oil systems through which oil flows, and the engine component 302 can be components of the oil systems, such as service tubes, for example.

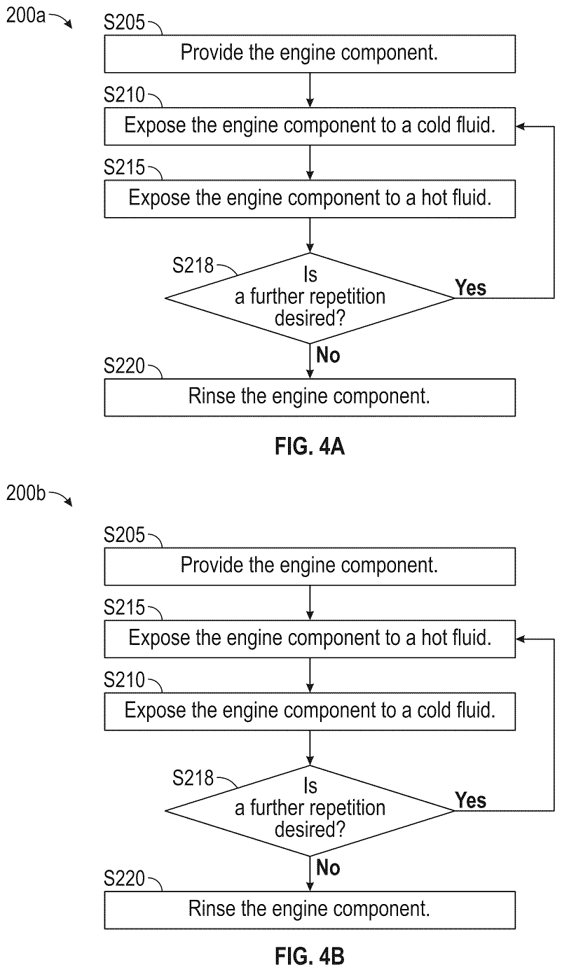

FIG. 4A is a flow chart illustrating a method of cleaning a component of a turbine engine, according to the present disclosure. A first step S205 includes providing the engine component. In some methods, the engine component is removed from the turbine engine for cleaning. Thus, engine components of the turbine engine may be cleaned piecewise, which may allow for easier control of conditions of the engine component, such as heat conditions. In other methods, the engine component remains in the turbine engine during the cleaning.

A cold-fluid step S210 includes exposing the engine component to a cold fluid. A cold fluid includes a cold liquid or a cold gas. The cold fluid can have a temperature ranging from negative fifty (−50) degrees Celsius (C) to negative two hundred seventy-one (−271) degrees C. The colder the cold fluid is, a greater thermal shock will be experienced by the coked surface of the engine component when the coked surface of the engine component is subsequently exposed to a hot fluid, thus allowing for better loosening and detachment, spallation, or shedding of the coke as fine particles from the interior surface of the engine component due to a higher degree of structural transformation of coke into a friable or brittle form. In some embodiments, the cold fluid can include solid particles entrained in the cold fluid. The engine component can be exposed to the cold fluid by immersion or spraying, as will be discussed further below.

A hot-fluid step S215 includes exposing the engine component to a hot fluid. The hot fluid may include a hot liquid or a hot gas. The hot fluid can have a temperature ranging from forty (40) degrees C. to two hundred eighty-five (285) degrees C. A greater temperature difference between the cold fluid and the hot fluid results in a greater thermal shock that will be experienced by the coked surface of the engine component, and the temperature difference can be increased by increasing the temperature of the hot fluid, similar to the effect of decreasing the temperature of the cold fluid. In some methods, a temperature differential between the cold fluid and the hot fluid is from ninety (90) degrees C. to five hundred fifty-six (556) degrees C. A high temperature differential allows for higher thermal shock, which generally promotes a structural transformation of coke to a more friable or brittle form, leading to detachment, spallation, or shedding of coke as fine particles from the interior surface of the engine component. The engine component can be exposed to the hot fluid by immersion or spraying, as will be discussed further below.

As seen in FIG. 4A, the cold-fluid step S210 is performed first. After the cold-fluid step S210 is performed, the hot-fluid step S215 is next performed. In some methods, a time between ending exposure of the engine component to the cold fluid of the cold-fluid step S210 and exposing the engine component to the hot fluid of the hot-fluid step S215 is from greater than zero (0) seconds to less than or equal to sixty (60) seconds. A quicker transfer of the engine component from a cold fluid to a hot fluid allows better loosening and detachment, spallation, or shedding of the coke from the interior surface of the engine component because the quicker transfer gives the engine component less time to reach equilibrium with temperatures outside the hot fluid and the cold fluid, such as, for example, room temperature, promoting a sudden drastic structural transformation of the coke to a more friable or brittle form. Accordingly, minimizing the time between commencing a hot-fluid step S215 after a cold-fluid step S210 increases the amount of thermal shock that aids in loosening and detaching, spalling, or shedding the coke from the interior surface of the engine component.

After the cold-fluid step S210 and the hot-fluid step S215 are performed, a decision step S218 is performed. The decision step S218 includes determining whether to repeat the cold-fluid step S210 and the hot-fluid step S215 again. Thus, the cold-fluid step S210 and the hot-fluid step S215 may be repeated in cycles until further repetition is no longer desired. Repeating a performance of the cold-fluid step S210 and then the hot-fluid step S215 is a cycle. In some embodiments, the cold fluid and the hot fluid have the same phase, such that there is no phase change between the cold fluid and the hot fluid when cycling between the cold fluid and the hot fluid. A cycle may be performed multiple times, such as being performed from one (1) time to ten (10) times or from two (2) times to ten (10) times. Further repetition may result in higher levels of cleaning of the engine component. Hence, further repetition may no longer be desired when, for instance, coke on the engine component is substantially loosened. Coke on the engine component is substantially loosened if the coke on interior surfaces of the engine component can be rinsed off the interior surfaces of the engine component such that the interior surfaces of the engine component are free of a certain percentage of coke after rinsing, such as surfaces being from seventy (70) percent to one hundred (100) percent free of coke, from eighty (80) percent to one hundred (100) percent free of coke, from ninety (90) percent to one hundred (100) percent free of coke, or from ninety-five (95) percent to one hundred (100) percent free of coke. The higher the percentage free of coke the engine component is, the better the operation of the engine is, because coked surfaces lead to a deterioration of engine components, as discussed above (for example, clogging throughways in the engine and stifling fluid flow, which causes issues in the engine, such as running too hot). Thus, if coke on interior surfaces of the engine component is not substantially loosened, the cold-fluid step S210 and the hot-fluid step S215 are repeated pursuant to a decision made by the decision step S218. On the other hand, if coke on interior surfaces of the engine is substantially loosened, then the decision step S218 will result in no further repetition desired. If further repetition is no longer desired, a rinsing step S220 is next performed, wherein the engine component is rinsed.

A last step comprises a rinsing step S220, including rinsing the engine component. Rinsing the engine component may include removing residue (such as loosened residue) of the substance to be cleaned still on the engine component, removing any fluid (such as hot fluid or cold fluid) remaining on the engine component, or removing a combination of the two. Rinsing may be accomplished by any method to wash coke away with rinsing fluid or exposing the engine component to rinsing fluid, including immersing the engine component in rinsing fluid and/or spraying the coke with rinsing fluid. Details on how the engine component is rinsed (i.e., by immersion or by spraying) will be discussed further below.

FIG. 4B is a flow chart illustrating a method of cleaning a component of a turbine engine, according to the present disclosure. FIG. 4B is a flow chart illustrating a method 200b substantially similar to the method 200a shown in FIG. 4A. The same reference numerals or similar reference numerals will be used for steps of the method 200b that are the same as or similar to the steps of the method 200a discussed above. The description of these steps above also applies to this embodiment, and a detailed description of these steps is omitted here.

The method 200b of FIG. 4B differs from the method 200a of FIG. 4A in that the method 200b includes performing the hot-fluid step S215 after the first step S205 of providing the engine component, whereas the method 200a of FIG. 4A includes performing the cold-fluid step S210 next after the first step S205 of providing the engine component. In some methods, a time between ending exposure of the engine component to the hot fluid of the hot-fluid step S215 and exposing the engine component to the cold fluid of the cold-fluid step S210 is from greater than zero (0) seconds to less than or equal to sixty (60) seconds. Similar to the discussion above (on the transfer to a hot fluid after a cold-fluid step S210), minimizing the time between commencing a cold-fluid step S210 after a hot-fluid step S215 increases the amount of thermal shock experienced by the coked surface of the engine component. The thermal shock aids in loosening and detaching, spalling, or shedding the coke from the interior surface of the engine component. Similar to the method 200a, in the method 200b, repeating a performance of the hot-fluid step S215 and then the cold-fluid step S210 is a cycle.

In reference to FIGS. 4A and 4B, the hot-fluid step S215 and the cold-fluid step S210 can be performed in any order, as seen by methods 200a and 200b, and these steps can be cycled in any order. However, in preferred methods, the hot-fluid step S215 and the cold-fluid step S210 are to be performed sequentially (i.e., one right after the other), and the hot-fluid step S215 and the cold-fluid step S210 are to be cycled sequentially (i.e., one after the other, multiple times over), without intervening steps, until the coke on the surface being cleaned is loosened or removed sufficiently to perform the rinsing step. Once coke on the interior surface of the engine component is sufficiently loosened or removed to perform the rinsing step S220, the hot-fluid step S215 should be performed as quickly as possible. In some methods, a time between (a) ending exposure of the engine component to the hot fluid of the hot-fluid step S215 and beginning the rinsing step S220 or (b) ending exposure of the engine component to the cold fluid of the cold-fluid step S210 and beginning the rinsing step S220 is from greater than zero (0) seconds to less than or equal to sixty (60) seconds. Minimizing the time between the hot-fluid step S215 and the rinsing step S220 or the cold-fluid step S210 and the rinsing step S220 allows for better coke removal during rinsing, as the coke has less time to adhere back to the interior surface of the engine component. In some embodiments, where a spray nozzle directs hot fluid and cold fluid onto the interior surface of the engine component, a spray nozzle may first spray hot fluid into the main orifices 131 (FIG. 2) of the fuel nozzle 82 (FIG. 2). Next, the spray nozzle may spray cold fluid into the main orifices 131. In other embodiments, the spray nozzle may first spray cold fluid into the main orifices 131. Next, the spray nozzle may spray hot fluid into the main orifices 131.

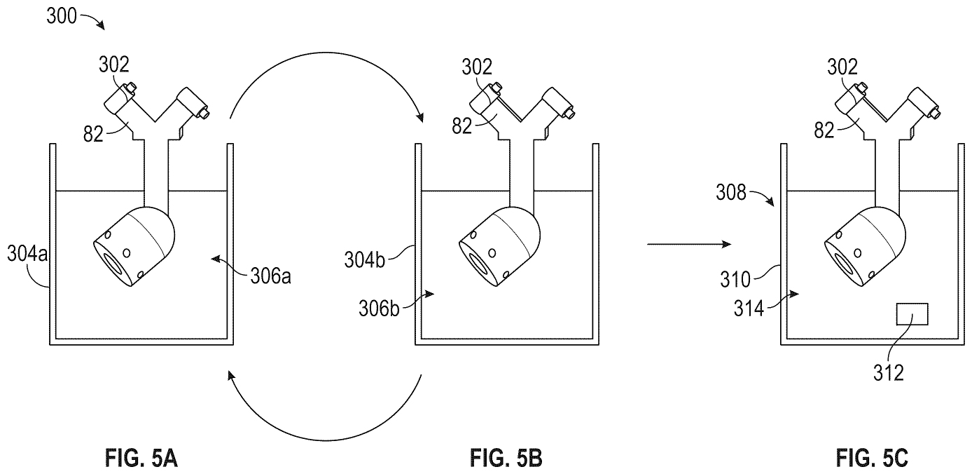

FIGS. 5A to 5C schematically illustrate a method 300 of cleaning a component of the turbine engine using a cleaning system according to the present disclosure. FIG. 5A shows the hot-fluid step S215 discussed above with reference to FIG. 4A or FIG. 4B. FIG. 5B shows a cold-fluid step S210 discussed above with reference to FIG. 4A or FIG. 4B. FIG. 5C shows a rinsing step S220 discussed above with reference to FIG. 4A or FIG. 4B.

In FIG. 5A, an engine component 302 (here, a fuel nozzle 82) is immersed in a hot fluid 306a contained in a hot-fluid container 304a. Immersing the engine component 302 in the hot fluid 306a, may include placing the engine component 302 in a hot-fluid container 304a filled with the hot fluid 306a, which is a performance of the hot-fluid step S215 (FIGS. 4A and 4B). In some methods, a time of exposure of the engine component 302 to the hot fluid 306a is from thirty (30) seconds to ninety (90) seconds.

The hot fluid 306a can be a liquid. In some embodiments, the hot fluid 306a may include one or more liquids of a variety of hot liquids. In some embodiments, the hot fluid 306a has a temperature ranging from forty (40) degrees C. to two hundred eighty-five (285) degrees C. As stated in the discussion of FIGS. 4A and 4B, a hotter temperature of a hot fluid 306a can result in better removal of coke from an interior surface, not only due to an increased temperature difference between hot and cold treatments/exposures, but also due to an improved solvation capability of certain fluids towards coke species at higher temperatures. A hot liquid can be water or a solvent. The solvent can be one of ethanol; 1-butanol; 1-methyl-2-pyrrolidinone; 1-butylpyrrolidin-2-one; 2,5,7,10-tetraoxaundecane; 1-benzyl-2-pyrrolidinone; 1-octyl-2-pyrrolidone; 1-cyclohexyl-2-pyrrolidone; cyrene; 4-formylmorpholine; ethyl acetate; propylene carbonate; dimethyl carbonate; diethyl carbonate; 2-(2-butoxyethoxy) ethanol; alcohols, C9-11, ethoxylated; anisole; sulfolane; 1,3-dioxolane; dimethyl sulfoxide; and dimethyl formamide, or the solvent can be any mixture of the aforementioned compounds. Further, the solvent can be any alkaline cleaning formulations, which may include the above solvents and/or a combination of alkali, surfactant, emulsifier, and/or solvent compounds or substances. In some embodiments, the hot fluid is water, NMP, a mixture including water, a mixture including NMP, or a mixture including both water and NMP. In some embodiments, the hot fluid 306a is mostly water, such as from fifty-one (51) percent water to one hundred (100) percent water or from ninety (90) percent water to one hundred (100) percent water. Having high amounts of water as the hot fluid 306a is beneficial due to a reasonably high boiling point of water (i.e., water can reach high temperatures before entering a gas phase and can transfer heat to an engine component). In some embodiments, the hot fluid 306a is mostly NMP, such as from fifty-one (51) percent NMP to one hundred (100) percent NMP or from ninety (90) percent NMP to one hundred (100) percent NMP. Having high amounts of NMP as the hot fluid 306a is beneficial due to NMP's high boiling point (even higher than water). In some embodiments, the density of the hot fluid 306a may be from seven hundred eighty-nine (789) kg/m³ to one thousand two hundred sixty-one (1261) kg/m³. Higher density in a hot fluid 306a generally allows for higher heat transfer into an engine component in the hot fluid, which may result in greater thermal shock when the engine component transfers to a cold fluid 306b.

In other embodiments, the hot fluid 306a includes one or more gases of a variety of gaseous states. A hot gas can be gaseous water or a gaseous solvent. The gaseous solvent can be one of gaseous forms of ethanol; 1-butanol; 1-methyl-2-pyrrolidinone; 1-butylpyrrolidin-2-one; 2,5,7,10-tetraoxaundecane; 1-benzyl-2-pyrrolidinone; 1-octyl-2-pyrrolidone; 1-cyclohexyl-2-pyrrolidone; cyrene; 4-formylmorpholine; ethyl acetate; propylene carbonate; dimethyl carbonate; diethyl carbonate; 2-(2-butoxyethoxy) ethanol; alcohols, C9-11, ethoxylated; anisole; sulfolane; 1,3-dioxolane; dimethyl sulfoxide; and dimethyl formamide, or any mixture of the aforementioned hot gaseous compounds. Further, the gaseous solvent can be any alkaline cleaning formulations, which may include the above gaseous solvents and/or a combination of alkali, surfactant, emulsifier, and/or solvent compounds or substances.

In some embodiments, the engine component 302 is immersed in only one of the exemplary hot fluids. In other embodiments, the engine component 302 is immersed in a mixture of two or more of the exemplary hot fluids. In some embodiments, when the engine component 302 is immersed in hot liquid, the hot liquid is agitated or excited via ultrasonication. In other embodiments, when the engine component 302 is immersed in hot liquid, the hot liquid is not agitated or excited via ultrasonication.

In FIG. 5B, the engine component 302 is immersed in a cold fluid 306b contained in a cold-fluid container 304b, including a cold liquid, a cold gas, or both a cold liquid and a cold gas. Immersing the engine component 302 in the cold fluid 306b may include placing the engine component 302 in a cold-fluid container 304b filled with the cold fluid 306b, which is a performance of the cold-fluid step S210 (FIGS. 4A and 4B). In some methods, the time of exposure of the engine component 302 to the cold fluid 306b is from thirty (30) seconds to ninety (90) seconds.

In some embodiments, the cold fluid 306b, such as a cold liquid, has a temperature ranging from negative seventy-eight (−78) degrees C. to negative two hundred seventy-one (−271) degrees C. As stated in the discussion of FIGS. 4A and 4B, a colder temperature of a cold fluid 306b can result in better removal of coke from an interior surface due to an increased temperature difference between hot and cold treatments or exposures, i.e., there is greater thermal shock experienced by the coked surface, leading to a greater degree of a structural transformation of the coke to a friable or brittle form. The cold fluid 306b may include one or more liquids of a variety of cold liquids. A cold liquid may include any of liquid helium-4, liquid hydrogen, liquid neon, liquid nitrogen, liquid air, liquid fluorine, liquid argon, liquid oxygen, liquid methane, and liquid carbon dioxide, or the cold liquid may include any mixture of the aforementioned cold liquids. In some embodiments, the cold fluid 306b comprises mostly liquid nitrogen, such as from fifty-one (51) percent liquid nitrogen to one hundred (100) percent liquid nitrogen or ninety (90) percent liquid nitrogen to one hundred (100) percent liquid nitrogen. Higher amounts of liquid nitrogen may lend to greater thermal shock, as liquid nitrogen can be an effective coolant and has a very low freezing point. In some embodiments, the density of the cold liquid may be from seventy-one (71) kg/m³ to one thousand five hundred thirteen (1513) kg/m³. Coolants (such as a cold fluid 306b) with higher densities are generally better at absorbing heat from objects immersed in the coolants.

In other embodiments, the cold fluid 306b, such as a cold gas, has a temperature ranging from negative fifty (−50) degrees C. to negative two hundred sixty-nine (−269) degrees C. The cold fluid 306b may include one or more gases of a variety of cold gases. A cold gas may include any of gaseous helium-4, gaseous hydrogen, gaseous neon, gaseous nitrogen, gaseous air, gaseous fluorine, gaseous argon, gaseous oxygen, gaseous methane, and gaseous carbon dioxide, or the cold gas may include any mixture of the aforementioned cold gases. In some embodiments, the density of the cold gas may be from 0.09 kg/m³ to 1.98 kg/m³. Generally, denser cold gases allow for quicker cooling of the engine component, which allows for more effective thermal shock when the engine component is thereafter transferred to a hot fluid 306a. In some embodiments, a heat capacity ratio is a heat capacity of a gas at constant pressure divided by a heat capacity of a gas at constant volume. In some embodiments, the heat capacity ratio of the cold gas is from 1.29 to 1.67.

In some embodiments, the engine component 302 is immersed in only one of the exemplary cold liquids. In other embodiments, the engine component 302 is immersed in a mixture of two or more of the exemplary cold liquids. When the engine component 302 is immersed in a cold liquid, the cold liquid may be agitated or excited via ultrasonication, or the cold liquid may not be agitated or excited via ultrasonication.

In FIG. 5C, the engine component is cleaned by immersing the engine component in a rinsing fluid 314. The engine component 302 is placed in fluid of a sonication bath 308 comprising a sonication bath container 310, the rinsing fluid 314, and a sonicator 312. The sonicator 312 agitates or excites particles of the rinsing fluid 314 by emitting ultrasonic energy while immersed in the rinsing fluid 314. The rinsing fluid 314 of the sonication bath 308 may include any liquid suitable for rinsing an engine component 302, such as deionized (DI) water, ethanol, any mixture consisting substantially of DI water and/or ethanol, or any mixture including DI water and/or ethanol and one or more other liquids suitable for rinsing. By agitating or exciting particles in the rinsing fluid 314, the rinsing fluid 314 loosens or removes particles from a surface of the engine component 302 immersed in the liquid of the sonication bath 308. Sonication baths may be one of many different immersion systems for immersing the engine component 302 in rinsing fluid.

The temperature of the rinsing fluid can be room temperature or an elevated temperature of, for example, about eighty (80) degrees C. In some embodiments, the temperature of the rinsing fluid is from negative one hundred fourteen (−114) degrees C. to one hundred (100) degrees C. In some methods, a time of exposure of the engine component 302 to the rinsing fluid 314 is from thirty (30) seconds to ten (10) minutes, such as about five (5) minutes.

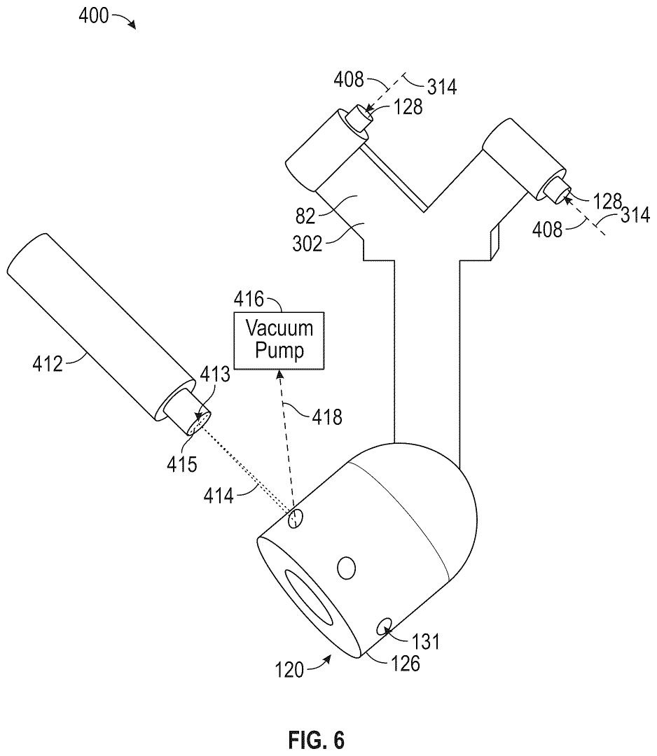

FIG. 6 is a schematic view of another cleaning system 400 that can be used to clean the engine component 302. Cleaning coke from surfaces may be achieved by spraying the engine component 302 with a hot fluid, a cold fluid, and/or a rinsing fluid.

The cleaning system 400 includes one or more spray nozzles 412 that release a spray nozzle stream 414, wherein the hot fluid, the cold fluid, and/or the rinsing fluid is sprayed into an orifice, such as the main orifice 131, of the fuel nozzle 82 and into the fuel nozzle tip 120. In some embodiments, a spray nozzle 412 has a spray nozzle orifice 413 with a spray-nozzle-orifice inner diameter 415 from 0.2 mm to 0.5 mm. A smaller spray-nozzle-orifice inner diameter may allow for a higher pressure of the spray from the spray nozzle 412, which may create more pressure on coked interior surfaces of the engine component, such that the interior surfaces of the engine component 302 are heated up faster, the interior surfaces of the engine component 302 are cooled down faster, and/or the coke is removed from the interior surfaces of the engine component 302 more effectively. In other embodiments, the spray-nozzle-orifice inner diameter 415 is from 0.5 mm to five (5) mm. A greater spray-nozzle-orifice inner diameter may allow for a broader surface-area coverage of the spray from the spray nozzle 412 to heat up surfaces of the engine component 302 quicker, cool down surfaces of the engine component 302 quicker, or remove coke that is on an interior surface of the engine component 302 quicker.

In some embodiments, there are two spray nozzles 412, a hot-fluid spray nozzle for spraying hot fluid and cold-fluid spray nozzle for spraying cold fluid. In some embodiments, the hot-fluid spray nozzle first sprays hot fluid into the main orifices 131, and the cold-fluid spray nozzle thereafter sprays cold fluid into the main orifices 131. In other embodiments, the cold-fluid spray nozzle first sprays cold fluid into the main orifices 131, and the hot-fluid spray nozzle thereafter sprays hot fluid into the main orifices 131. FIG. 6 depicts the spray nozzle stream 414 being sprayed into the main orifices 131, but the spray nozzle 412 can direct the spray nozzle stream 414 into any opening of the engine component 302 (e.g., the fuel nozzle 82), such as, for example, into a pilot nozzle 142 (FIG. 3) to clean coke from flow paths of the fuel nozzle 82 by directing hot fluid and cold fluid onto interior surfaces of the fuel nozzle 82 to loosen the coke thereof and/or directing rinsing fluid onto the interior surfaces of the fuel nozzle 82 to rinse away the coke thereof.

Exposing the engine component 302 to the cold fluid may include spraying the engine component 302 with the cold fluid to perform the cold-fluid step S210 (FIGS. 4A and 4B) and may include spraying the cold fluid onto a surface of the engine component 302, such as a dirty surface of the engine component 302 or a coked surface of the engine component 302. Spraying the cold fluid onto the surface of the engine component 302 includes spraying the cold fluid directly against the surface of the engine component 302 (such as a flow of the cold fluid orthogonal or substantially orthogonal to the surface of the engine component 302), spraying the cold fluid against the surface of the engine component 302 at an angle of less than ninety (90) degrees and greater than zero (0) degrees, or spraying the cold fluid past the surface of the engine component 302 (including spraying the cold fluid such that it touches the surface of the engine component 302 but flows parallel or substantially parallel to the surface of the engine component 302). In some methods, during a cold-fluid step S210, the cold fluid is directed into a flow passage of the engine component 302 to flow over the surface of the engine component 302.

In some embodiments, the cold fluid, such as a cold liquid, may be sprayed onto the engine component 302 or past the engine component 302 at a flow velocity from four (4) m/s to three hundred (300) m/s. A higher flow velocity allows for the cold fluid to cool down interior surfaces of the engine component 302 faster, and/or to remove coke from surfaces of the engine component more efficiently. A higher flow rate, in standard liter per minute (SLM), of the hot fluid, the cold fluid, or the rinsing fluid through passageways of an engine component may result in the same effect as higher flow velocity. Flow rate ranges for the cold liquid may be from 0.01 SLM to five (5) SLM, from ten (10) SLM to two hundred fifty (250) SLM, from five (5) SLM to four hundred (400) SLM, or from fifty (50) SLM to nine hundred (900) SLM. In some embodiments, pressure drop variations for when the cold liquid is sprayed may be from two (2) psi to four hundred (400) psi, such as from seventy (70) psi to two hundred (200) psi. Higher pressure drop affects the cleaning of coke, in that higher pressure drop generally causes a higher removal of coke via the methods and systems discussed in this disclosure. In some embodiments, the cold fluid, such as a cold gas, may be sprayed onto the engine component 302 or past the engine component 302 at a flow velocity from five (5) m/s to one thousand (1000) m/s. In some embodiments, flow rate ranges for the cold gas may be from 0.01 SLM to fifty (50) SLM, from fifteen (15) SLM to five hundred (500) SLM, from thirty (30) SLM to eight hundred (800) SLM, or from one hundred (100) SLM to three thousand (3000) SLM. In some embodiments, pressure drop variations for when the cold gas is sprayed may be from 0.02 psi to ten (10) psi. In other embodiments, pressure drop variations for when the cold gas is sprayed may be from 0.2 psi to twenty (20) psi.

Exposing the engine component 302 to the hot fluid may include spraying the hot fluid onto a surface of the engine component 302, such as a dirty surface of the engine component 302 or a coked surface of the engine component 302. Spraying the hot fluid onto the surface of the engine component 302 includes spraying the hot fluid directly against the surface of the engine component 302 (such as spraying a flow of the hot fluid orthogonal or substantially orthogonal to the surface of the engine component 302), spraying the hot fluid against the surface of the engine component 302 at an angle of less than ninety (90) degrees and greater than zero (0) degrees, or spraying the hot fluid past the surface of the engine component 302 (including spraying the hot fluid such that the hot fluid touches the surface of the engine component 302, but flows parallel or substantially parallel to the surface of the engine component 302). In some methods, during a hot-fluid step S215 (FIGS. 4A and 4B), the hot fluid is directed into a flow passage of the engine component 302 to flow over the surface of the engine component 302.

In some embodiments, the hot fluid is sprayed onto the engine component 302 or past the engine component 302 at a flow velocity from four (4) m/s to one hundred (100) m/s. In further embodiments, the hot fluid includes one or more hot gases, directed as hot jets of the one or more gases, the one or more hot gases being sprayed onto the engine component 302 or past the engine component 302 at a flow velocity ranging from four (4) m/s to three hundred (300) m/s. In some embodiments, flow rate ranges for the hot fluid, in standard litres per minute (SLM), may be from 0.01 SLM to five (5) or from ten (10) SLM to three hundred (300) SLM. In some embodiments, pressure drop variations for when the hot fluid is sprayed may be from two (2) psi to four hundred (400) psi, such as from seventy (70) psi to two hundred (200) psi.

In some embodiments, the spray nozzle 412 may spray cold solid pellets as part of a gaseous fluid onto the engine component 302 during the cold-fluid step S210 (FIGS. 4A and 4B). The cold fluid can be a gaseous fluid including cold solid pellets therein. The cold solid pellets can be from negative fifty (−50) degrees C. to negative two hundred and seventy-three (−273) degrees C., such as being pellets of carbon dioxide in compressed air having a temperature of about negative seventy-eight (−78) degrees C. The pellets may be frozen states of any of the cold liquids of Table 1 below, with a diameter of the pellets ranging from 0.01 mm to 3 mm, including from 0.01 mm to 0.2 mm, from 0.1 mm to 0.5 mm, from 0.5 mm to 2 mm, and from 1 mm to 3 mm. Using pellets in the aforementioned ranges of smaller size is beneficial, as smaller sized pellets allow for the cleaning of a surface while preserving inherent surface roughness. Further, smaller sized pellets allow for better unclogging of narrow tubes and orifices of components herein. In some embodiments, the pellets are sized to have a length and/or diameter of less than or equal to 0.2 mm. In further embodiments, the pellets have a length:diameter ratio of 16:5. For instance, the pellets may have a length:diameter ratio ranging from 0.2 mm: 0.0625 mm to 0.8 mm: 0.25 mm or from 0.2 mm: 0.0625 mm to 8 mm: 2.5 mm. In other embodiments, the length:diameter ratio ranges from 1:1 to 16:5 or from 1:1 to 10:1. An aspect ratio of the pellets within these ranges allows for more efficient cleaning of a substrate. Particularly, aspect ratios closer to 3:1 allow for highly effective cleaning via dry ice blasting. In some embodiments, the flow velocity of the spraying of the cold solid pellets is a range from eighty (80) m/s to six hundred (600) m/s, such as from one hundred fifty (150) m/s to two hundred fifty (250) m/s or from two hundred fifty (250) m/s to four hundred fifty (450) m/s. The solid pellets can be dry ice (i.e., carbon dioxide pellets) sprayed using compressed air onto or past the surface of the engine component 302. A dry ice consumption rate (how much dry ice is consumed) is from eight (8) kg/h to ten (10) kg/h, and the minimum distance of the spray nozzle 412 for dry ice blasting is between 12 to 80 mm from the engine component 302. Keeping the nozzle at a distance such as one found in the aforesaid ranges allows for a substrate to be cleaned effectively without damaging the substrate, taking into account the ranges of the diameter and length of the pellets discussed herein. In preferred embodiments, the angle of the flow of dry ice pellets to the surface being blasted is about ninety (90) degrees. In some embodiments, dry ice pellets are substantially carbon dioxide pellets.

To remove residue or debris that is unstuck from the surface of the fuel nozzle 82 (after spraying the hot fluid and the cold fluid onto the surface of the fuel nozzle), such as coke that is loosened or removed from sticking on the surface of the fuel nozzle 82, a vacuum pump 416 may create suction through one or more orifices in a vacuum pump flow direction 418 to suck the residue or the debris into the vacuum pump 416. The vacuum pump 416 may, for instance, suction loosened residue or debris through the main orifices 131 of the fuel nozzle 82 or through the pilot orifice(s) 124 of the fuel nozzle 82.

In some embodiments, rinsing the engine component 302 includes directing a rinsing fluid stream 408 to an entryway of the engine component 302 (such as to the valve ends 128 of the fuel nozzle 82), therefore, creating a pressurized flow of rinsing fluid 314 through a flow passage of the engine component 302. Thus, the rinsing fluid may flow through the main passage 134 (FIG. 2) and/or through the pilot passage 144 (FIG. 2) to rinse coke off of interior surfaces that the rinsing fluid 314 runs along. The pressurized flow of rinsing fluid 314 may exit through the main orifices 131 positioned annularly around a side surface of the fuel nozzle 82 or through the pilot orifice(s) 124 (FIG. 3) positioned at the fuel-nozzle downstream end 126 after flowing through the main passage 134 (FIG. 2) or pilot passage 144 (FIG. 2).

The flow velocity of a pressurized flow of rinsing fluid 314 through the engine component 302 or of a spray of rinsing fluid 314 into or onto an engine component 302 may range from one (1) m/s to five hundred (500) m/s, or, even more specifically, one (1) m/s to one hundred (100) m/s. As discussed above, a higher pressurized flow of rinsing fluid may allow for better removal of coke; however, it should be known that the methods and systems herein can be carried out even with lower velocity flows of rinsing fluid.

Table 1, below, provides cold liquids, including their temperature ranges for use, densities, and flow velocity ranges, when directed or sprayed toward the engine component 302.

TABLE 1

| | Temperature | | |
|---|---|---|---|
| Cold | range of use | Density | Flow velocity |
| liquid | (° C.) | (kg/m³) | (m/s) |
| Helium-4 | −269 to −271 | 125 | 14 to 250 |
| Hydrogen | −253 to −259 | 71 | 15 to 300 |
| Neon | −246 to −249 | 1206 | 4 to 80 |
| Nitrogen | −196 to −210 | 804 | 5 to 100 |
| Air | −194 to −213 | 870 | 5 to 100 |
| Fluorine | −188 to 220 | 1513 | 4 to 80 |
| Argon | −186 to −189 | 1394 | 4 to 80 |
| Oxygen | −183 to −219 | 1141 | 4 to 80 |
| Methane | −161 to −182 | 423 | 8 to 150 |
| Carbon | −78 | 771 | 5 to 100 |
| dioxide | | | |

An exemplary cold solid in a gaseous fluid may include carbon dioxide and compressed air. The temperature may be about negative seventy-eight (−78) degrees, and the flow velocity sub-ranges for blasting into coked hardware orifices may broadly be from eighty (80) m/s to six hundred (600) m/s, including from one hundred fifty (150) m/s to two hundred fifty (250) m/s and from two hundred fifty (250) m/s to four hundred fifty (450) m/s.

Table 2, below, provides exemplary cold gases, including their temperature ranges for use, densities, heat capacity ratios, and flow velocity ranges, when directed or sprayed toward the engine component 302.

TABLE 2

| | | | | Flow | |
|---|---|---|---|---|---|
| | | | | velocity | |
| | | | | (m/s) (at | Flow |
| | Temper- | | | approx. the | velocity |
| | ature range | | | boiling point | (m/s) (at |
| | of use | Density | Cₚ/ | of the fluid of | approx. −50° |
| Cold gas | (° C.) | (kg/m³) | Cᵥ | the cold gas) | C.) |
| Helium-4 | −50 to −269 | 0.18 | 1.67 | 5 to 150 | 40 to 900 |
| Hydrogen | −50 to −253 | 0.09 | 1.41 | 10 to 350 | 50 to 1000 |
| Neon | −50 to −246 | 0.90 | 1.67 | 5 to 150 | 15 to 400 |
| Nitrogen | −50 to −196 | 1.25 | 1.40 | 5 to 200 | 10 to 300 |
| Air | −50 to −194 | 1.23 | 1.40 | 5 to 200 | 10 to 300 |
| Fluorine | −50 to −188 | 1.70 | 1.40 | 5 to 150 | 10 to 300 |
| Argon | −50 to −186 | 1.78 | 1.67 | 5 to 200 | 10 to 300 |
| Oxygen | −50 to −183 | 1.43 | 1.40 | 5 to 200 | 10 to 300 |
| Methane | −50 to −161 | 0.72 | 1.31 | 10 to 300 | 15 to 400 |
| Carbon | −50 to −77 | 1.98 | 1.29 | 5 to 200 | 10 to 250 |
| dioxide | | | | | |

Table 3, below, provides exemplary hot liquids, including their temperature ranges for use, densities, and flow velocity ranges, when directed or sprayed toward the engine component 302.

TABLE 3

| | Use | Density | |
|---|---|---|---|
| | temperature | (kg/m³) | |
| Warm/hot liquid | range (° C.) | (Approx.) | Flow velocity (m/s) |
| Water | 60 to 100 | 958 to 997 | 5 to 80 |
| Ethanol | 40 to 78 | 789 | 5 to 90 |
| 1-Butanol | 60 to 117 | 810 | 5 to 90 |
| 1-Methyl-2- | 60 to 202 | 1028 | 5 to 80 |
| pyrrolidinone | | | |
| 1-Butylpyrrolidin-2- | 60 to 247 | 900 to 1100 | 5 to 80 |
| one | | | |
| 2,5,7,10- | 60 to 245 | 980 | 5 to 80 |
| Tetraoxaundecane | | | |
| 1-Benzyl-2- | 60 to 78 | 1095 | 5 to 80 |
| pyrrolidinone | | | |
| 1-Octyl-2-pyrrolidone | 60 to 172 | 920 | 5 to 80 |
| 1-Cyclohexyl-2- | 60 to 284 | 1007 | 5 to 80 |
| pyrrolidone | | | |
| Cyrene | 60 to 227 | 1250 | 4 to 70 |
| 4-Formylmorpholine | 60 to 245 | 1145 | 4 to 70 |
| Ethyl acetate | 40 to 77 | 902 | 5 to 80 |
| Propylene carbonate | 60 to 240 | 1200 | 4 to 70 |
| Dimethyl carbonate | 40 to 89 | 1070 | 5 to 80 |
| Diethyl carbonate | 60 to 128 | 975 | 5 to 80 |
| 2-(2- | 60 to 230 | 954 to 960 | 5 to 80 |
| Butoxyethoxy)ethanol | | | |
| Alcohols, C9-11, | 60 to 260 | 993 | 5 to 80 |
| ethoxylated | | | |
| Anisole | 60 to 154 | 995 | 5 to 80 |
| Sulfolane | 60 to 285 | 1261 | 4 to 70 |
| 1,3-dioxolane | 40 to 78 | 1064 | 5 to 80 |
| Dimethyl sulfoxide | 60 to 189 | 1100 | 5 to 80 |
| Dimethyl formamide | 60 to 153 | 944 | 5 to 80 |

The present disclosure provides the benefit of cleaning coked surfaces from an engine component. Surfaces that build up coke due to fuel flow or oil flow pose operational and maintenance problems in aircraft engines. The present disclosure allows for the cleaning of coked surfaces even in hard-to-reach areas, such as a narrow flow path through the fuel nozzle 82. Cycling between exposing an engine component between a hot fluid and a cold fluid, and, thereafter, rinsing after cycling, allows for loosening and/or removal of coke from a surface needing to be cleaned to improve the efficiency and performance of a turbine engine.

Further aspects are provided by the subject matter of the following clauses.

A method of cleaning coke from an engine component, the method including providing the engine component including a flow passage having coke formed within the flow passage, performing a hot-fluid step including exposing the engine component to a hot fluid, performing a cold-fluid step including exposing the engine component to a cold fluid, the cold fluid being colder than the hot fluid by a temperature differential to remove the coke from the engine component, the temperature differential being from ninety (90) degrees C. to five hundred fifty-six (556) degrees C., and rinsing the engine component with a rinsing fluid to remove coke from the engine component.

A method of cleaning coke from an engine component. The method comprises providing the engine component including a flow passage having coke formed within the flow passage, performing one of a hot-fluid step including exposing the engine component to a hot fluid or a cold-fluid step including exposing the engine component to a cold fluid, performing the other of the hot-fluid step or the cold-fluid step, and rinsing the engine component with a rinsing fluid. The cold fluid is colder than the hot fluid by a temperature differential to remove the coke from the engine component, the temperature differential being from ninety (90) degrees C. to five hundred fifty-six (556) degrees C.

The method of any preceding clause, further comprising repeating the hot-fluid step and the cold-fluid step at least once.

The method of any preceding clause, further comprising repeating the hot-fluid step and the cold-fluid step from two (2) times to ten (10) times.

The method of any preceding clause, wherein the hot fluid is from forty (40) degrees C. to two hundred eighty-five (285) degrees C.

The method of any preceding clause, wherein the cold fluid is from negative fifty (−50) degrees C. to negative two hundred seventy-one (−271) degrees C.

The method of any preceding clause, wherein the rinsing fluid is a mixture including distilled water or ethanol.

The method of any preceding clause, wherein the rinsing fluid is directed into a flow passage of the engine component.

The method of any preceding clause, further comprising performing the hot-fluid step and the cold-fluid step multiple times in two or more cycles, wherein the hot-fluid step is performed before the cold-fluid step in each cycle of the two or more cycles.

The method of any preceding clause, wherein at most sixty (60) seconds elapse between (a) ending exposure of the engine component to the hot fluid and exposing the engine component to the cold fluid or (b) ending exposure of the engine component to the cold fluid and exposing the engine component to the hot fluid.

The method of any preceding clause, wherein the hot fluid is sprayed onto a coked surface of the engine component during the hot-fluid step, and the cold fluid is sprayed onto the coked surface of the engine component during the cold-fluid step.

The method of any preceding clause, wherein the engine component is a fuel nozzle, and the hot fluid is sprayed onto a coked surface of the fuel nozzle through orifices of the fuel nozzle during the hot-fluid step, and the cold fluid is sprayed onto the coked surface of the fuel nozzle through the orifices of the fuel nozzle during the cold-fluid step.

The method of any preceding clause, wherein the cold fluid is gaseous fluid including cold solid pellets therein.

The method of any preceding clause, wherein the cold solid pellets range from negative fifty (−50) degrees C. to negative two hundred and seventy-three (−273) degrees C.

The method of any preceding clause, wherein the cold fluid is a cold gas.

The method of any preceding clause, wherein the cold fluid includes at least one of helium-4, hydrogen, neon, nitrogen, air, fluorine, argon, oxygen, methane, or carbon dioxide.

The method of any preceding clause, wherein the engine component is immersed in the rinsing fluid for rinsing the engine component.

The method of any preceding clause, wherein the engine component is rinsed via a sonication bath.

The method of any preceding clause, wherein the cold fluid is a cold liquid.

The method of any preceding clause, wherein the cold fluid includes a cold liquid, and the cold liquid is from ninety (90) percent liquid nitrogen to one hundred (100) percent liquid nitrogen.

The method of any preceding clause, wherein the hot fluid is a solvent.

The method of any preceding clause, wherein the hot fluid is water, N-methyl pyrrolidone, a mixture including water, or a mixture including N-methyl pyrrolidone.

A method of cleaning coke from an engine component. The method comprises providing the engine component including a flow passage having coke formed within the flow passage, performing a hot-fluid step including exposing the engine component to a hot fluid, performing a cold-fluid step including exposing the engine component to a cold fluid, the cold fluid being colder than the hot fluid by a temperature differential to remove the coke from the engine component, the temperature differential being from ninety (90) degrees C. to five hundred fifty-six (556) degrees C., and rinsing the engine component with a rinsing fluid. At least one of the hot-fluid step, the cold-fluid step, or the rinsing step includes immersing the engine component in a fluid.

The method of the preceding clause, wherein the engine component is immersed in the hot fluid in a hot-fluid container.

The method of any preceding clause, wherein the engine component is immersed in the cold fluid in a cold-fluid container.

The method of any preceding clause, wherein the engine component is immersed in the rinsing fluid.

The method of any preceding clause, wherein the engine component is immersed in a sonication bath having a sonicator.

The method of any preceding clause, wherein a hot-fluid sonicator is in the hot-fluid container.

The method of any preceding clause, wherein a cold-fluid sonicator is in the cold-fluid container.

The method of any preceding clause, wherein the hot fluid in the hot-fluid container is a liquid.

The method of any preceding clause, wherein the hot fluid in the hot-fluid container is a gas.

The method of any preceding clause, wherein the hot-fluid container includes a mixture of a liquid and a gas as the hot fluid.

The method of any preceding clause, wherein the cold fluid in the cold-fluid container is a liquid.

The method of any preceding clause, wherein the cold fluid in the cold-fluid container is a gas.

The method of any preceding clause, wherein the cold-fluid container includes a mixture of a liquid and a gas as the cold fluid.

The method of any preceding clause, wherein the sonication bath includes deionized water, ethanol, or a mixture of deionized water and ethanol.

The method of any preceding clause, wherein the engine component is immersed in the cold fluid for thirty (30) seconds to ninety (90) seconds.

The method of any preceding clause, wherein the engine component is immersed in the hot fluid for thirty (30) seconds to ninety (90) seconds.

The method of any preceding clause, wherein the engine component is immersed in the rinsing fluid for thirty (30) seconds to ten (10) minutes.

The method of any preceding clause, wherein the engine component is removed from the cold fluid of the cold-fluid container and transferred to the hot fluid of the hot-fluid container for immersion, wherein the time between removing the engine component from the cold-fluid and immersing the engine component in the hot fluid is from greater than zero (0) seconds to less than or equal to sixty (60) seconds.

The method of any preceding clause, wherein the engine component is removed from the hot fluid of the hot-fluid container and transferred to cold fluid of the cold-fluid container for immersion, wherein the time between removing the engine component from the hot fluid and immersing the engine component in the cold fluid is from greater than zero (0) seconds to less than or equal to sixty (60) seconds.

The method of any preceding clause, wherein the engine component is removed from the hot fluid of the hot-fluid container or the cold fluid of the cold-fluid container, and is transferred to and immersed in the rinsing fluid, wherein the time between removing the engine component from the hot fluid or the cold fluid and immersing the engine component in the rinsing fluid is from greater than zero (0) seconds to less than or equal to sixty (60) seconds.

A method of cleaning coke from an engine component. The method comprises providing the engine component including a flow passage having coke formed within the flow passage, performing a hot-fluid step including exposing the engine component to a hot fluid, performing a cold-fluid step including exposing the engine component to a cold fluid, the cold fluid being colder than the hot fluid by a temperature differential to remove the coke from the engine component, the temperature differential being from ninety (90) degrees C. to five hundred fifty-six (556) degrees C., and rinsing the engine component with a rinsing fluid. At least one of the hot-fluid step, the cold-fluid step, or the rinsing step includes spraying a fluid onto a surface of the engine component.

The method of any preceding clause, wherein an interior surface of the engine component is sprayed with hot fluid.

The method of any preceding clause, further comprising spraying the hot fluid through an orifice of the engine component.

The method of any preceding clause, wherein the engine component is a fuel nozzle, and further comprising spraying the hot fluid through a main orifice of the fuel nozzle or spraying the hot fluid through a pilot orifice of the fuel nozzle.

The method of any preceding clause, wherein an interior surface of the engine component is sprayed with the cold fluid.

The method of any preceding clause, further comprising spraying the cold fluid through the orifice of the engine component.

The method of any preceding clause, wherein the engine component is a fuel nozzle, and further comprising spraying the cold fluid through the main orifice of the fuel nozzle or spraying the cold fluid through the pilot orifice of the fuel nozzle.

The method of any preceding clause, wherein a spray nozzle having a spray nozzle orifice sprays the hot fluid or the cold fluid through the spray nozzle orifice and toward an orifice or an interior surface of the engine component.

The method of any preceding clause, wherein the spray nozzle orifice has a spray-nozzle-orifice inner diameter from 0.2 mm to 0.5 mm.

The method of any preceding clause, wherein the spray nozzle orifice has a spray-nozzle-orifice inner diameter from 0.5 mm to five (5) mm.

The method of any preceding clause, wherein the hot fluid is sprayed onto the engine component by a hot-fluid spray nozzle and the cold fluid is sprayed onto the engine component by a cold-fluid spray nozzle.

The method of any preceding clause, wherein the hot fluid is sprayed substantially parallel to the surface of the engine component.

The method of any preceding clause, wherein the hot fluid is sprayed onto the surface of the engine component at an angle of less than ninety (90) degrees and greater than zero (0) degrees.

The method of any preceding clause, wherein the hot fluid is sprayed onto the surface of the engine component orthogonally to the surface of the engine component.

The method of any preceding clause, wherein the cold fluid is sprayed substantially parallel to the surface of the engine component.

The method of any preceding clause, wherein the cold fluid is sprayed onto the surface of the engine component at an angle of less than ninety (90) degrees and greater than zero (0) degrees.

The method of any preceding clause, wherein the cold fluid is sprayed onto the surface of the engine component orthogonally to the surface of the engine component.

The method of any preceding clause, wherein the hot fluid is sprayed at a flow velocity from four (4) m/s to one hundred (100) m/s.

The method of any preceding clause, wherein the cold fluid is sprayed at a flow velocity from four (4) m/s to three hundred (300) m/s.

The method of any preceding clause, wherein the rinsing fluid is sprayed at a flow velocity from one (1) m/s to one thousand (1000) m/s.

A system for cleaning coke from an engine component. The system comprises an engine component including a flow passage having coke formed within the flow passage, a hot fluid, a cold fluid being colder than the hot fluid by a temperature differential to remove the coke from the engine component, the temperature differential being from ninety (90) degrees C. to five hundred fifty-six (556) degrees C., and a rinsing fluid for rinsing the engine component.

The system of the preceding clause, wherein the hot fluid is either from fifty-one (51) percent NMP to one hundred (100) percent NMP or from fifty-one (51) percent water to one hundred (100) percent water.

The system of any preceding clause, wherein the cold fluid is from fifty-one (51) percent liquid nitrogen to one hundred (100) percent liquid nitrogen.

The system of any preceding clause, wherein a time of exposure of the engine component to the hot fluid or the cold fluid is from thirty (30) seconds to ninety (90) seconds.

The system of any preceding clause, wherein a time of exposure of the engine component to the rinsing fluid is from one (1) second to ten (10) minutes.

The system of any preceding clause, wherein a time between ending exposure of the engine component to the hot fluid and exposing the engine component to the cold fluid or ending exposure of the engine component to the cold fluid and exposing the engine component to the hot fluid is from one (1) second to sixty (60) seconds.

The system of any preceding clause, wherein the cold fluid includes a cold gas, the cold gas having a heat capacity ratio from 1.29 to 1.67.

The system of any preceding clause, wherein the hot fluid and cold fluid are sprayed from two different nozzles, each spray nozzle having a spray-nozzle orifice inner diameter from 0.2 mm to 0.5 mm.

The system of any preceding clause, wherein the hot fluid is sprayed onto the engine component or past the engine component at a flow velocity from four (4) m/s to one hundred (100) m/s.

The system of any preceding clause, wherein the cold fluid includes a cold liquid, and the cold liquid is sprayed onto the engine component or past the engine component at a flow velocity from four (4) m/s to three hundred (300) m/s.

The system of any preceding clause, wherein the cold fluid includes a cold gas, and the cold gas is sprayed onto the engine component or past the engine component at a flow velocity from five (5) m/s to one thousand (1000) m/s.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A method of cleaning coke from an engine component, the method comprising:
providing the engine component including a flow passage having coke formed within the flow passage;
performing a hot-fluid step including exposing the engine component to a hot fluid;
performing a cold-fluid step including exposing the engine component to a cold fluid, the cold fluid being colder than the hot fluid by a temperature differential to remove the coke from the engine component, the temperature differential being from ninety (90) degrees C. to five hundred fifty-six (556) degrees C.; and
rinsing the engine component with a rinsing fluid to remove coke from the engine component.

2. The method of claim 1, further comprising repeating the hot-fluid step and the cold-fluid step at least once.

3. The method of claim 1, further comprising repeating the hot-fluid step and the cold-fluid step from two (2) times to ten (10) times.

4. The method of claim 1, wherein the hot fluid is from forty (40) degrees C. to two hundred eighty-five (285) degrees C.

5. The method of claim 1, wherein the cold fluid is from negative fifty (−50) degrees C. to negative two hundred seventy-one (−271) degrees C.

6. The method of claim 1, wherein the rinsing fluid is a mixture including distilled water or ethanol.

7. The method of claim 1, wherein the rinsing fluid is directed into a flow passage of the engine component.

8. The method of claim 1, further comprising performing the hot-fluid step and the cold-fluid step multiple times in two or more cycles, wherein the hot-fluid step is performed before the cold-fluid step in each cycle of the two or more cycles.

9. The method of claim 1, wherein at most sixty (60) seconds elapse between (a) ending exposure of the engine component to the hot fluid and exposing the engine component to the cold fluid or (b) ending exposure of the engine component to the cold fluid and exposing the engine component to the hot fluid.

10. The method of claim 1, wherein the hot fluid is sprayed onto a coked surface of the engine component during the hot-fluid step, and the cold fluid is sprayed onto the coked surface of the engine component during the cold-fluid step.

11. The method of claim 1, wherein the engine component is a fuel nozzle, and the hot fluid is sprayed onto a coked surface of the fuel nozzle through orifices of the fuel nozzle during the hot-fluid step, and the cold fluid is sprayed onto the coked surface of the fuel nozzle through the orifices of the fuel nozzle during the cold-fluid step.

12. The method of claim 1, wherein the cold fluid is gaseous fluid including cold solid pellets therein, the cold solid pellets ranging from negative fifty (−50) degrees C. to negative two hundred and seventy-three (−273) degrees C.

13. The method of claim 1, wherein the cold fluid is a cold gas.

14. The method of claim 1, wherein the cold fluid includes at least one of helium-4, hydrogen, neon, nitrogen, air, fluorine, argon, oxygen, methane, or carbon dioxide.

15. The method of claim 1, wherein the engine component is immersed in a sonication bath including the rinsing fluid for rinsing the engine component.

16. The method of claim 1, further comprising performing a first cold-fluid step before a first hot-fluid step.

17. The method of claim 1, wherein the cold fluid is a cold liquid.

18. The method of claim 17, wherein the cold fluid includes a cold liquid, and the cold liquid is from ninety (90) percent liquid nitrogen to one hundred (100) percent liquid nitrogen.

19. The method of claim 1, wherein the hot fluid is a solvent.

20. The method of claim 19, wherein the hot fluid is water, N-methyl pyrrolidone, a mixture including water, or a mixture including N-methyl pyrrolidone.
